(19) United States
(12) Patent Application Publication
(10) Pub. No.: US 2025/0371829 A1
(43) Pub. Date: Dec. 4, 2025

(54) INFORMATION PROCESSING DEVICE FOR CORRECTING POSITION OF VIRTUAL OBJECT, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: MAIKI OKUWAKI, Kanagawa (JP)

(21) Appl. No.: 19/213,177

(22) Filed: May 20, 2025

(30) Foreign Application Priority Data
May 31, 2024 (JP) 2024-088840

(51) Int. Cl. G06T 19/20; G06T 7/20; G06T 7/70

(52) U.S. Cl. CPC G06T 19/20; G06T 7/20; G06T 7/70; G06T 2219/2004

(57) ABSTRACT

An information processing device acquires an image of a virtual space, detects a first position that is a position of a real object in a first captured image of a real space, detects a second position that is either a position of the real object in a second captured image referred to when generating the image of the virtual space or a position of a virtual object associated with the real object in the image of the virtual space, determines a motion vector indicating a direction and an amount of movement of the virtual object in the image of the virtual space based on the first position and the second position, and corrects the position of the virtual object in the image of the virtual space based on the motion vector.

### BACKGROUND OF THE INVENTION

### Field of the Invention

The present invention relates to an information processing device, an information processing method, and a non-transitory computer-readable storage medium.

### Description of the Related Art

In Virtual Reality (VR) and Mixed Reality (MR) systems, it is important to reduce the time (delay time) between imaging and display. When the delay time is extended, the user may experience motion sickness or feel a sense of incongruity in the image. It is generally desirable that the delay time be within 20 ms, and various efforts have been made to reduce the delay time. In particular, in an MR system, when it takes a long time to render a virtual object that follows the user's hand, the position of the hand in the image in the real space and the virtual object may be misaligned, causing a sense of incongruity in the MR image.

In Japanese Patent Application Publication No. 2020-71718, the position and orientation of a moving virtual object are predicted and rendered, and the position at which an image is displayed is shifted based on the amount of change in the latest position or orientation of an image display device, thereby correcting the misalignment between a background image and a virtual image. However, when the movement of the virtual object is irregular, accurate position prediction becomes difficult, resulting in a position displacement of the virtual object.

In Japanese Patent Application Publication No. 2020-167660, the movement of the object from a background image is detected, and a virtual image is generated by predicting the position and orientation until the time of display. In this case, rendering of the virtual image takes time, and when the object moves in a manner different from the prediction during that time, the position at which the virtual object is superimposed will be shifted.

### SUMMARY OF THE INVENTION

The present invention provides a technology for placing a virtual object in a more appropriate position when synthesizing an image in the real space with an image in the virtual space.

The present invention in its one aspect provides an information processing device including one or more processors and/or circuitry configured to perform an image acquisition process for acquiring an image of a virtual space, perform a first detection process for detecting a first position that is a position of a real object in a first captured image of a real space, perform a second detection process for detecting a second position that is either a position of the real object in a second captured image referred to when generating the image of the virtual space or a position of a virtual object associated with the real object in the image of the virtual space, perform a determination process for determining a motion vector indicating a direction and an amount of movement of the virtual object in the image of the virtual space based on the first position and the second position, and perform a correction process for correcting the position of the virtual object in the image of the virtual space based on the motion vector.

The present invention in its one aspect provides an information processing method including acquiring an image of a virtual space, detecting a first position that is a position of a real object in a first captured image of a real space, detecting a second position that is either a position of the real object in a second captured image referred to when generating the image of the virtual space or a position of a virtual object associated with the real object in the image of the virtual space, determining a motion vector indicating a direction and an amount of movement of the virtual object in the image of the virtual space based on the first position and the second position, and correcting the position of the virtual object in the image of the virtual space based on the motion vector.

Further features of the present invention will become apparent from the following description of exemplary embodiments with reference to the attached drawings.

### BRIEF DESCRIPTION OF THE DRAWINGS

FIG. 1 is a hardware configuration diagram of an information processing device according to a first embodiment;

FIG. 2 is a software configuration diagram of the information processing device according to the first embodiment;

FIG. 3 is a flowchart of a synthetic image generation process according to the first embodiment;

FIGS. 4A to 4I are diagrams for explaining the misalignment between a background image and a virtual image according to the first embodiment;

FIGS. 5A to 5F are diagrams for explaining a synthetic image generation process according to the first embodiment;

FIG. 6 is a flowchart of a synthetic image generation process according to a second embodiment;

FIGS. 7A to 7O are diagrams for explaining the misalignment between a background image and a virtual image according to the second embodiment;

FIGS. 8A to 8J are diagrams for explaining a synthetic image generation process according to the second embodiment; and

FIGS. 9A to 9E are diagrams for explaining a motion vector based on depth information according to the second embodiment.

### DESCRIPTION OF THE EMBODIMENTS

Hereinafter, the embodiments of the present invention will be explained with reference to the drawings. The following embodiments do not limit the present invention, and not all of the combinations of features explained in the present embodiment are necessarily essential to the solution of the present invention. The configuration of the embodiments may be appropriately corrected or changed depending on the specifications of the device to which the present invention is applied and various conditions (such as the conditions of use and the environment of use). In addition, some of the embodiments described later may be appropriately synthesized.

### First Embodiment

Hereinafter, the configuration and operation of an information processing device 10 according to the first embodiment will be explained. The information processing device 10 is connected to a head-mounted display (HMD; e.g., a glasses-type device) worn on the user's head. Alternatively, the information processing device 10 is incorporated in the HMD worn on the user's head. The information processing device 10 may be an HMD or a control device that controls the HMD.

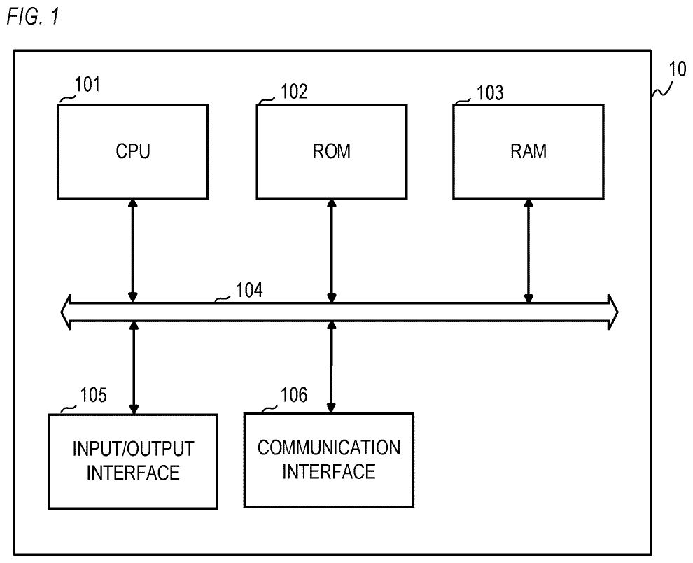

FIG. 1 shows an example of a hardware configuration of an information processing device 10 according to the first embodiment. The information processing device 10 has a CPU 101, a ROM 102, a RAM 103, a bus 104, an input/output interface 105, and a communication interface 106. All components of the information processing device 10 except for the bus 104 are connected to each other via the bus 104.

The CPU 101 is a calculation device (control unit) that comprehensively controls the system. The CPU 101 performs various processes by executing various programs stored in the ROM 102 and the like.

The ROM 102 stores programs (image processing programs or programs that do not require modification such as initial data) and parameters. The ROM 102 is a read-only non-volatile memory device.

The RAM 103 temporarily stores input information from various devices and calculation results in image processing. The RAM 103 is also a memory device that provides a work area for the CPU 101. For example, the RAM 103 stores images (background image and rendered virtual image) and position and orientation data (position and orientation data of the HMD and position and orientation data of the controller).

The input/output interface 105 is an interface unit capable of inputting and outputting digital data such as image information.

The communication interface 106 is an interface unit capable of transmitting and receiving data to and from a server or the like via a network.

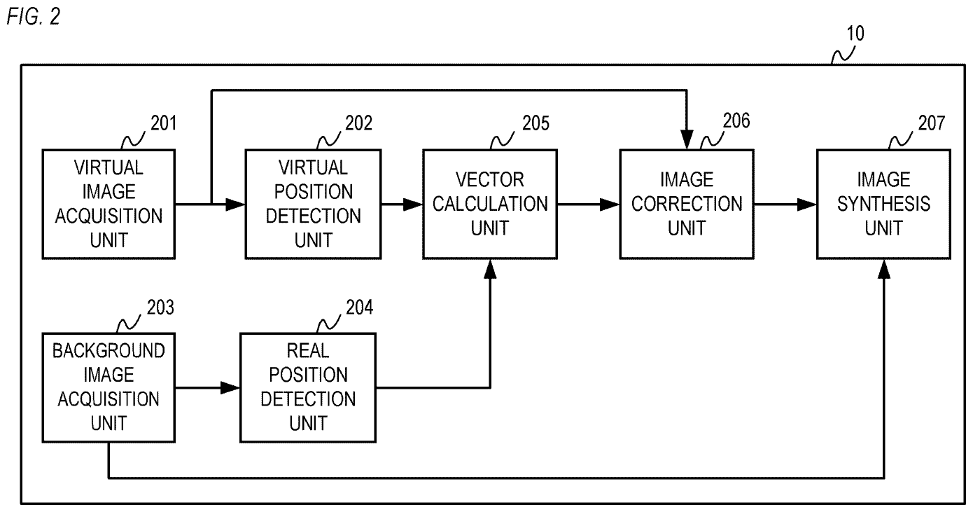

FIG. 2 is a diagram showing an example of the software logical configuration of the information processing device 10. The information processing device 10 has a virtual image acquisition unit 201, a virtual position detection unit 202, a background image acquisition unit 203, a real position detection unit 204, a vector calculation unit 205, an image correction unit 206, and an image synthesis unit 207.

The virtual image acquisition unit 201 reads an image (virtual image) in which the virtual space recorded in the RAM 103 is rendered. The virtual image acquisition unit 201 may acquire a virtual image transmitted from the input/output interface 105 or the communication interface 106.

The virtual position detection unit 202 performs image processing on the virtual image acquired from the virtual image acquisition unit 201. In this way, the virtual position detection unit 202 calculates the position of a moving virtual object in the virtual image. The virtual position detection unit 202 may calculate the position of the virtual object by reading the position and orientation of the virtual object sequentially recorded in the RAM 103.

The background image acquisition unit 203 reads a background image (captured image) recorded in the RAM 103. The background image is an image of a real space (a real space including a real object) captured by an imaging device. The background image acquisition unit 203 may acquire a background image transmitted from the input/output interface 105 or the communication interface 106.

The real position detection unit 204 calculates the position of a real object in the background image acquired from the background image acquisition unit 203. The real object is an object being tracked, such as a user's hand or a controller. The real position detection unit 204 may calculate the position of the real object based on the position and orientation of the real object recorded in the RAM 103.

The vector calculation unit 205 calculates a motion vector (motion vector of the virtual object) indicating the direction and amount of movement of the virtual object based on the position of the virtual object detected by the virtual position detection unit 202 and the position of the real object detected by the real position detection unit 204.

The image correction unit 206 moves the virtual object in the virtual image obtained from the virtual image acquisition unit 201 based on the motion vector of the virtual object obtained from the vector calculation unit 205. In this way, the image correction unit 206 corrects the virtual image.

The image synthesis unit 207 synthesizes the corrected virtual image with the background image obtained from the background image acquisition unit 203. In this way, the image synthesis unit 207 generates a synthetic image (MR image).

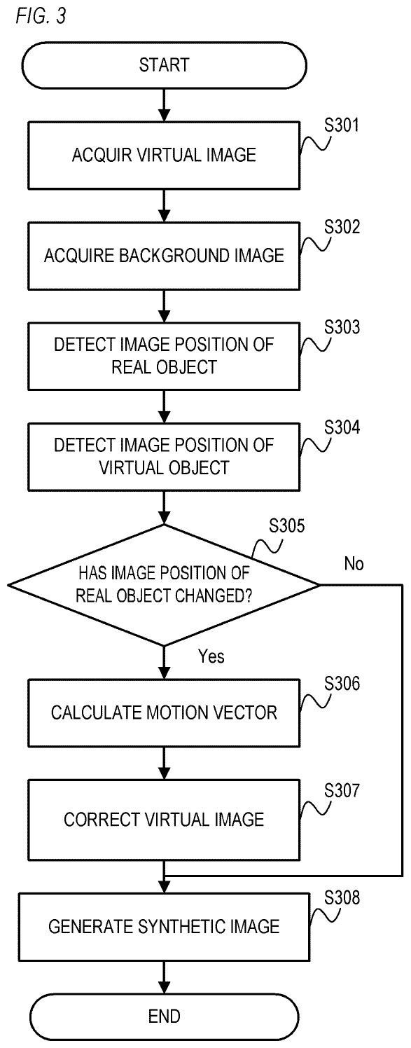

The synthetic image generation process according to the first embodiment will be described with reference to the flowchart in FIG. 3. The process of the flowchart in FIG. 3 is executed every frame.

In step S301, the virtual image acquisition unit 201 acquires a virtual image recorded in the RAM 103. The virtual image is an image in which color information (such as RGB components) and transparency information of a virtual object are recorded.

In step S302, the background image acquisition unit 203 acquires a background image recorded in the RAM 103.

In step S303, the real position detection unit 204 detects (calculates) the position of a real object (a real object moving in the real space) in the background image (hereinafter, the position of the real object in the background image is referred to as the “image position of the real object”). The real object is an object whose position and orientation are tracked by the information processing device 10. The real object is, for example, the user's hand or a controller.

The real position detection unit 204 may detect the image position of the real object based on the difference between the background image of the current frame and the background image of the previous frame (the frame immediately before the current frame). Alternatively, the real position detection unit 204 may detect the image position of the real object based on the position and orientation of the real object being tracked (the position and orientation of the real object in the real space). Note that, for example, the position and orientation of the controller can be calculated by self-position estimation using sensor values measured by sensors provided on the controller. The position and orientation of the hand or the controller may also be calculated based on the result of image processing on an image captured by a camera provided on the HMD or the controller. The position and orientation of the hand or the controller may be calculated using a camera or a sensor installed outside the HMD.

For example, when a camera captures the light pattern of an LED provided on a controller held by a user, the position and orientation of the controller may be calculated based on the captured image of the light pattern. In addition, when an image of a moving real object is recognized by performing image recognition processing on an image captured by a camera attached to the HMD, the image position of the real object may be calculated based on the result of the image recognition. For example, the user's hand appearing in the image captured by the camera may be identified by image recognition processing to detect the image position and image area of the hand.

In step S304, the virtual position detection unit 202 detects the position of a moving virtual object in the virtual image (hereinafter, the position of the virtual object in the virtual image is referred to as the “image position of the virtual object”). The virtual object is a virtual object corresponding to the real object being tracked (a virtual object associated with the real object). The virtual object is, for example, a virtual object held by the user with the hand or the controller in the MR space. For example, the virtual position detection unit 202 can detect the image position of the virtual object by acquiring data specifying the image position and image area of the virtual object determined when the virtual object is rendered.

The virtual position detection unit 202 may also determine the image position of the virtual object based on the “camera parameters and position and orientation” of the HMD used when rendering the virtual image and the position and orientation of the real object being tracked. The virtual position detection unit 202 may also determine the image position of the virtual object based on a virtual object area that can be grasped from image information in which the image area of the moving virtual object is recorded. The virtual position detection unit 202 may also determine the image position of the virtual object based on the image difference (inter-frame difference) from the virtual image of the previous frame. The virtual position detection unit 202 may also record pixels having a motion difference from the previous time and determine the image position of the virtual object by searching around the pixel.

The virtual position detection unit 202 may also determine the position of the virtual object around the image position of the real object in the real space as the image position of the virtual object. The virtual position detection unit 202 may calculate the velocity vector of the real object in the real space, and determine the position of an area having a velocity vector of the virtual object similar to this velocity vector as the image position of the virtual object.

In step S305, the vector calculation unit 205 determines whether the image position of the real object has changed by a threshold or more. Note that the vector calculation unit 205 may determine whether the difference between the image position of the virtual object and the image position of the real object is a threshold or more, instead of the amount of change in the image position of the real object. For example, when it is determined that the amount of change in the image position of the real object between frames is a threshold or more, the process proceeds to step S306. When it is determined that the amount of change in the image position of the real object is less than the threshold, the process proceeds to step S308. Therefore, when it is determined that the amount of change in the image position of the real object is less than the threshold, the virtual image and the background image are synthesized without calculating the motion vector and correcting the virtual image (correcting the image position of the virtual object).

In step S306, the vector calculation unit 205 calculates (determines) a motion vector of the virtual object indicating the difference between the image position of the virtual object and the image position of the real object. The motion vector may be a two-dimensional vector representing a two-dimensional coordinate movement. In addition, a plurality of vectors may be calculated as the motion vector to move the area of the virtual object pixel by pixel.

In step S307, the image correction unit 206 moves (shifts) the display position of the area of the virtual object in the virtual image based on the motion vector of the virtual object. In this way, the image correction unit 206 corrects the virtual image.

In step S308, the image synthesis unit 207 generates a synthetic image by synthesizing the background image and the virtual image.

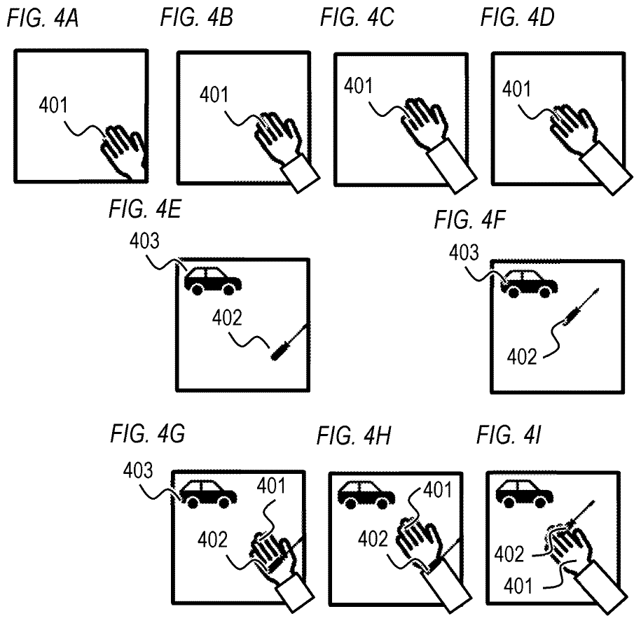

FIGS. 4A to 4I are diagrams for explaining the positional misalignment that occurs between the background image and the virtual image when the first embodiment is not used.

FIGS. 4A to 4D show background images for each frame, arranged in chronological order. Hand 401 is the user's hand that appears in the background image. In FIGS. 4A and 4B, the user's hand 401 moves to the upper left at a constant speed. The user's hand 401 in FIG. 4C moves in the same direction as the hand 401 in FIGS. 4A and 4B, but is moving faster (accelerating) than in those figures. The user's hand 401 in FIG. 4D moves in a different direction than the hand 401 in FIGS. 4A to 4C.

FIG. 4E and FIG. 4F show virtual images for each frame. Virtual object 402 is a virtual object associated with the user's hand 401. Virtual object 403 is a virtual object fixed in the virtual space (MR space). Since the rendering processing time of a virtual image is long, the virtual image is rendered at intervals of one frame for every two frames of the background image.

FIG. 4E shows how a virtual image (a virtual image to be synthesized with the background image shown in FIG. 4B) is rendered based on the positions and orientations of the HMD and hand at the time of capturing the background image shown in FIG. 4A and their velocities (angular velocities). During rendering, the time at which the virtual image being rendered is displayed on the display is predicted. Then, the position and orientation of the virtual object 402 is predicted based on “the image position of the hand 401 in the background image shown in FIG. 4A”, “velocity (angular velocity) information”, and “the time difference between capturing the background image shown in FIG. 4A to displaying the virtual image”. The virtual image is rendered based on the predicted position and orientation. Therefore, the image position of the virtual object 402 shown in FIG. 4E is a position obtained by correcting the image position of the hand 401 shown in FIG. 4A based on the speed of the HMD and the hand, the time required for processing, and the like. Similarly, FIG. 4F shows a state in which a virtual image to be synthesized with the background image shown in FIG. 4D is rendered based on the position and orientation of the HMD and the hand at the time of capturing the background image shown in FIG. 4C.

FIGS. 4G to 4I show a synthetic image in which the background image and the virtual image are synthesized.

FIG. 4G shows a synthetic image in which the background image shown in FIG. 4B and the virtual image shown in FIG. 4E are synthesized. During the time between the capture times of FIG. 4A and FIG. 4B, the user's hand moves at a constant speed. For this reason, the virtual object 402 is superimposed at the correct position in FIG. 4G by the position and orientation prediction process for rendering the virtual image shown in FIG. 4E.

In FIG. 4H, the background image of FIG. 4C and the virtual image of FIG. 4E are synthesized. In FIG. 4H, the virtual image shown in FIG. 4E of the previous frame is used, so the positions of the user's hand 401 and the virtual object 402 are misaligned.

In FIG. 4I, the background image shown in FIG. 4D and the virtual image shown in FIG. 4F are synthesized. The movement direction of the user's hand 401 shown in FIG. 4C is different from the movement direction of the user's hand 401 shown in FIG. 4D. As a result, the predicted position calculated when rendering the virtual image shown in FIG. 4F is misaligned from the position where the virtual object should actually be placed. Therefore, in FIG. 4I, the positions of the user's hand 401 and the virtual object 402 are misaligned.

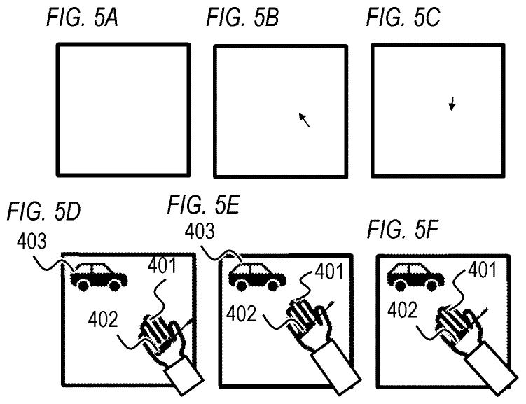

FIGS. 5A to 5F are diagrams for explaining the generation process of a synthetic image according to the first embodiment.

FIGS. 5A to 5C show a motion vector for moving a virtual object in a virtual image. The motion vector is calculated from the difference between the image position of the real object and the image position of the virtual object in the two images (background image and virtual image) used for synthesis when the virtual image is not corrected.

FIG. 5A shows a motion vector based on the image position of a real object in the real image shown in FIG. 4B and the image position of a virtual object in the virtual image shown in FIG. 4E. The motion vector shown in FIG. 5A shows that there is no difference between the image position of the user's hand 401 shown in FIG. 4B and the image position of the virtual object 402 shown in FIG. 4E.

FIG. 5B shows a motion vector based on the image position of a real object in the real image shown in FIG. 4C and the image position of a virtual object in the virtual image shown in FIG. 4E. The motion vector shown in FIG. 5B is calculated according to the difference between the image position of the user's hand 401 shown in FIG. 4C and the image position of the virtual object 402 shown in FIG. 4E. This motion vector shows that the image position of the virtual object 402 shown in FIG. 4E needs to be moved to the upper left. In other words, the accelerated movement of the user's hand shown in FIG. 4C should be reflected in the virtual image shown in FIG. 4E. The amount of movement of the motion vector is the same as the amount of movement from the image position of the user's hand 401 shown in FIG. 4B to the image position of the user's hand 401 shown in FIG. 4C.

FIG. 5C shows a motion vector based on the image position of the real object in the real image shown in FIG. 4D and the image position of the virtual object in the virtual image shown in FIG. 4F. The motion vector shown in FIG. 5C is calculated based on the difference between the image position of the user's hand 401 shown in FIG. 4D and the image position of the virtual object 402 shown in FIG. 4F. This motion vector indicates that the image position of the virtual object 402 shown in FIG. 4F needs to be moved downward. In other words, the movement of the user's hand 401, which has changed direction shown in FIG. 4D, should be reflected in the virtual image shown in FIG. 4F.

FIGS. 5D to 5F show synthetic images in which a background image and a virtual image are synthesized using the motion vectors of FIGS. 5A to 5C.

FIG. 5D shows a synthetic image obtained by synthesizing the “background image shown in FIG. 4B” and the “virtual image shown in FIG. 4E.” Since the motion vector shown in FIG. 5A has no components, no special processing is performed and the conventional synthesis processing is carried out as is.

FIG. 5E shows a synthetic image obtained by synthesizing the “background image shown in FIG. 4C” and the “image in which the virtual image in FIG. 4E is corrected.” The virtual image in FIG. 4E is synthesized with the background image after the virtual object 402 is moved according to the motion vector shown in FIG. 5B. In FIG. 5E, the virtual object 402 is superimposed on the user's hand 401 without a large positional misalignment. The virtual object 403 that does not correspond to the hand 401 does not move.

FIG. 5F shows a synthetic image obtained by synthesizing the “background image shown in FIG. 4D” and the “image in which the virtual image in FIG. 4F is corrected.” The virtual image in FIG. 4F is used for the synthesis after the virtual object 402 is moved according to the motion vector shown in FIG. 5C. Therefore, the virtual object 402 is superimposed on the user's hand 401 without a large positional misalignment.

According to the first embodiment, the display position of a virtual object (a virtual object displayed in association with a moving real object) in a virtual image rendered using a past position and orientation is corrected to a display position that reflects the latest position and orientation of the real object. This reduces the positional misalignment between the real object and the virtual object. In other words, the virtual object can be placed in a more appropriate position.

### Second Embodiment

In the second embodiment, the information processing device 10 corrects the velocity vector when synthesizing a virtual image after correcting the virtual image using the velocity vector and depth information of the virtual object. Thus, the positional misalignment of the virtual object is suppressed.

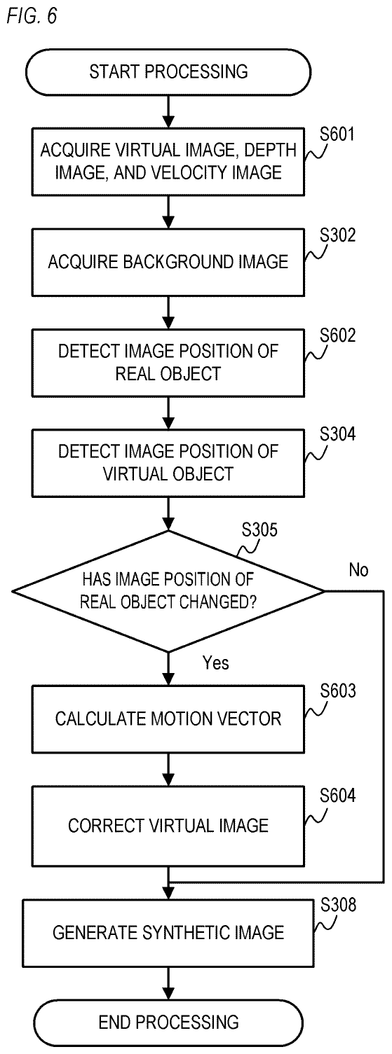

The process of generating a synthetic image (MR image) according to the second embodiment will be described with reference to the flowchart in FIG. 6. The process of this flowchart is executed for each frame. Since the processes of steps S302, S304, S305, and S308 are the same as those in the flowchart in FIG. 3, the same numbers are assigned and description is omitted.

In step S601, the virtual image acquisition unit 201 acquires a depth image and a velocity image in addition to the virtual image obtained by rendering the virtual space recorded in the RAM 103. The velocity image is an image indicating the velocity vector (velocity) of each pixel of the virtual object acquired during rendering (generation) of the virtual image. The depth image is an image indicating the depth of each pixel of the virtual object acquired during rendering of the virtual image.

When the movement of the virtual object is uniform, the velocity image has higher information accuracy than the motion vector calculated from the background image as in the first embodiment. In addition, since the velocity image can be calculated for each pixel, it has a higher resolution than the motion vector calculated from the background image as in the first embodiment. In addition, when the velocity image is used, it is possible to predict changes in the display of the virtual object, such as changes in occlusion due to the deformation and movement of the virtual object. On the other hand, when the movement of the virtual object (the real object on which the virtual object is superimposed) is not uniform, there is a possibility that the virtual object will be drawn in an incorrect position when the velocity image is used to draw (or correct) the virtual object.

In step S602, the real position detection unit 204 calculates the image position of the real object. When calculating the image position of the real object, the real position detection unit 204 may additionally record the depth information of the real object by acquiring depth information based on the background image.

In step S603, the vector calculation unit 205 calculates a motion vector of the virtual object based on the image position of the virtual object and the image position of the real object. The motion vector of the virtual object may be calculated using both the “velocity image of the virtual object with high movement accuracy and high resolution” and the “motion vector calculated from the most recent background image”. The motion vector may also be calculated as a three-dimensional motion vector based on the “image position and depth information of the real object in the real space” and the “image position and depth information of the virtual object”.

In step S604, the image correction unit 206 moves the display position of the area of the virtual object in the virtual image for each pixel based on the motion vector, depth image, and velocity image of the virtual object. In this way, the image correction unit 206 corrects the virtual image.

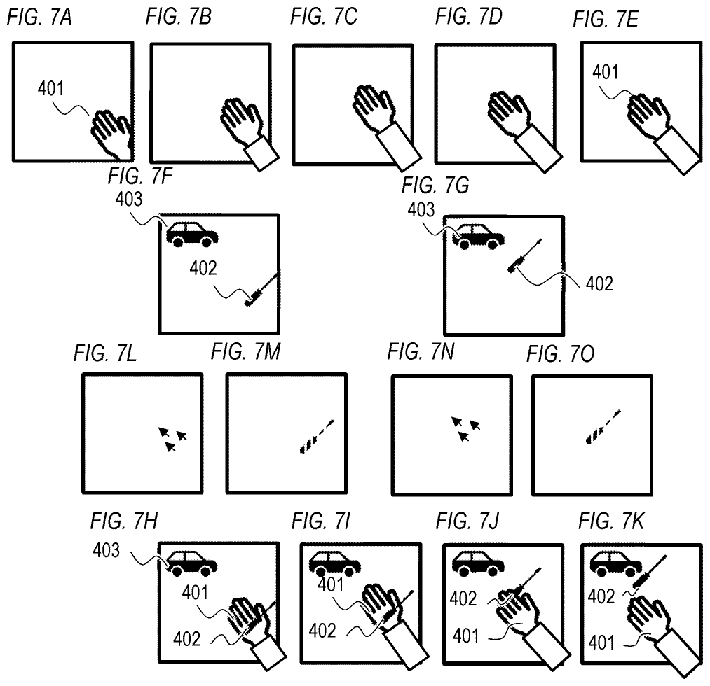

FIGS. 7A to 7O are diagrams for explaining the misalignment between the background image and the virtual image when the second embodiment is not used.

FIGS. 7A to 7E show background images for each frame, arranged in chronological order. FIGS. 7A to 7D are the same as FIGS. 4A to 4D. FIGS. 7F and 7G are the same as FIGS. 4E and 4F. FIGS. 7H and 7J are the same as FIGS. 4G and 4I.

FIG. 7E shows a background image showing a state in which the user's hand 401 is moving in the same direction as the hand 401 shown in FIG. 7D.

FIG. 7L shows a velocity image showing the velocity of a virtual object when the virtual image shown in FIG. 7F is rendered. FIG. 7N shows a velocity image showing the velocity of a virtual object when the virtual image shown in FIG. 7G is rendered.

FIG. 7M shows a depth image showing the depth of a virtual object when the virtual image shown in FIG. 7F is rendered. FIG. 7O shows a depth image representing the depth of the virtual object when the virtual image shown in FIG. 7G is rendered.

In FIG. 7I, the “background image shown in FIG. 7C” and the “corrected virtual image shown in FIG. 7F” are synthesized. The display position of the virtual object 402 in FIG. 7F is corrected using the velocity image in FIG. 7L and the depth image in FIG. 7M in the synthesis process. As a result, the positional misalignment of the virtual object 402 in FIG. 7F is reduced.

By using the velocity image, the image position of the virtual object 402 can be corrected using the velocity vector for each pixel, so that the sense of incongruity of the virtual object due to movement can be reduced. In addition, by using the depth image to correct the display position of the virtual object, it is possible to reproduce the change in occlusion (front-to-back relationship) due to spatial movement. In addition, the missing pixels due to movement can be filled based on the surrounding pixels.

On the other hand, in the background image shown in FIG. 7C, the user's hand 401 moves at a faster speed than in the previous frame. As a result, when the velocity image shown in FIG. 7N is used, the virtual object 402 cannot sufficiently follow the user's hand 401, as shown in FIG. 7J, and is superimposed at a position slightly away from the hand 401.

In FIG. 7K, the “background image shown in FIG. 7E” and the “image in which the virtual image shown in FIG. 7G is corrected” are synthesized. The display position of the virtual object 402 in the virtual image shown in FIG. 7G is corrected using the velocity image shown in FIG. 7N and the depth image shown in FIG. 7O. However, the velocity image shown in FIG. 7N is rendered based on information about the time of capturing the background image shown in FIG. 7C. As a result, the velocity and direction of the user's hand 401 are different between FIG. 7D and FIG. 7E. As a result, the virtual object 402 is superimposed at a position slightly away from the hand 401 in FIG. 7K.

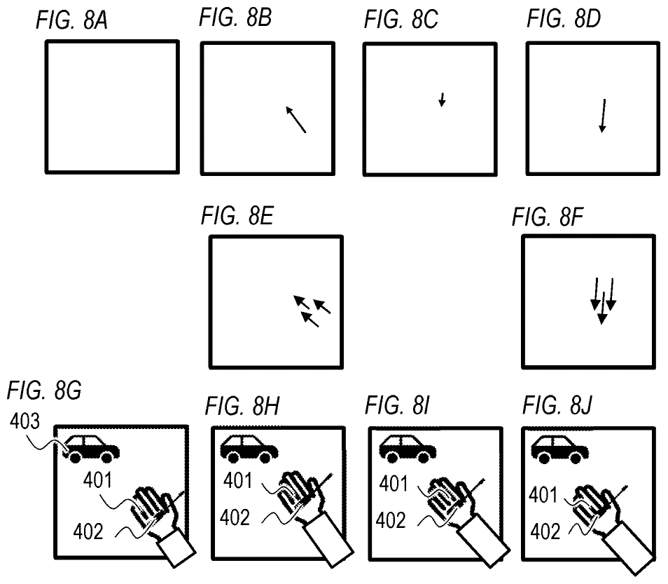

FIG. 8A to FIG. 8J are diagrams for explaining a synthetic image generation process according to the second embodiment. FIG. 8A to FIG. 8C are the same as FIG. 5A to FIG. 5C. FIG. 8G and FIG. 8I are the same as FIG. 5D and FIG. 5F.

FIG. 8D, like FIG. 8A to FIG. 8C, shows a motion vector calculated from the difference between the image position of the user's hand 401 shown in FIG. 7E and the image position of the virtual object 402 shown in FIG. 7G. This motion vector indicates that the image position of the virtual object 402 shown in FIG. 7G needs to be moved downward. This indicates that the movement of the user's hand shown in FIG. 7E is reflected.

FIG. 8E shows a velocity image obtained by correcting the velocity image shown in FIG. 7L based on the motion vector shown in FIG. 8B. FIG. 8F shows a velocity image obtained by correcting the velocity image shown in FIG. 7N based on the motion vector shown in FIG. 8D.

FIG. 8E shows the velocity image after correcting the velocity image shown in FIG. 7L based on the motion vector shown in FIG. 8B. Here, the direction of the velocity vector of the velocity image shown in FIG. 7L is the same as the direction of the motion vector of the virtual object shown in FIG. 8B. When the direction of the motion vector of the virtual object and the velocity vector of the velocity image are the same, the velocity image can be corrected by multiplying the velocity vector of the region of the virtual object 402 in the velocity image by a coefficient. The coefficient multiplication factor may be calculated based on the change in the motion vector of the real object.

The direction of the velocity vector may be corrected by adding the motion vector shown in FIG. 8B to the velocity vector of the velocity image shown in FIG. 7L. A three-dimensional vector calculated for each pixel may be used as the motion vector. For example, the three-dimensional vector can be calculated based on depth information acquired from the background image shown in FIG. 7E.

In addition, when comparing the direction of the motion vector and the direction of the velocity vector, if the angle formed by the two vectors is equal to or smaller than a threshold, the two directions may be determined to be the same. In addition, when it can be determined that the virtual object is continuing to move in the same direction as in the previous frame by referring to the information of the motion vector and the velocity vector of the previous frame, the direction of the motion vector and the velocity vector may be determined to be the same.

FIG. 8F shows a velocity image after correcting the velocity image shown in FIG. 7N based on the motion vector of the virtual object shown in FIG. 8D. In addition, the velocity vector of the velocity image shown in FIG. 7N and the motion vector of the virtual object shown in FIG. 8D have different directions. In this case, the direction of the velocity vector may be changed by adding the motion vector of the virtual object shown in FIG. 8D to the velocity image shown in FIG. 7N.

FIG. 8H shows a synthetic image obtained by synthesizing a background image and a virtual image after the position of the virtual object 402 in the virtual image (the virtual image shown in FIG. 7F) is corrected based on the velocity image shown in FIG. 8E and the depth image shown in FIG. 7M. FIG. 8J shows a synthetic image in which the background image and the virtual image are synthesized after the position of the virtual object 402 in the virtual image (the virtual image shown in FIG. 7G) is corrected based on the velocity image shown in FIG. 8F and the depth image shown in FIG. 7O.

In this way, by using the velocity image, the image position of the virtual object 402 can be corrected based on the velocity vector for each pixel. Thus, it is possible to further reduce the sense of incongruity caused by the shift in the display position of the virtual object 402 associated with the movement of the hand 401.

FIG. 8H shows a synthetic image in which the “background image shown in FIG. 7C” and the “corrected virtual image shown in FIG. 7F” are synthesized. The virtual image shown in FIG. 7F is corrected based on the velocity image shown in FIG. 8E and the depth image shown in FIG. 7M. In this way, the positional misalignment of the virtual object at the time of synthesis can be reduced. In FIG. 8H, the virtual object 402 can follow the accelerated movement of the user's hand 401 at the time of capturing the background image shown in FIG. 7C.

FIG. 8J shows a synthetic image obtained by synthesizing the “background image shown in FIG. 7E” and the “image in which the virtual image shown in FIG. 7G is corrected.” The virtual image shown in FIG. 7G is corrected based on the velocity image shown in FIG. 8F. In this way, the positional misalignment of the virtual object 402 relative to the hand 401 at the time of synthesis is reduced.

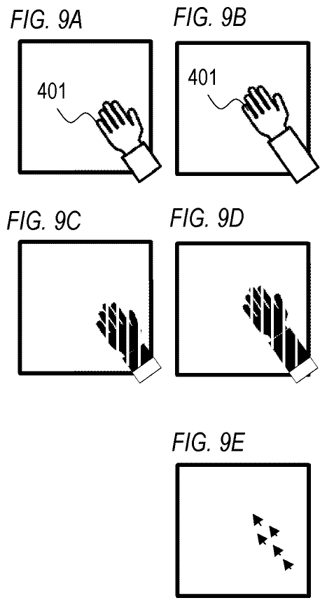

FIGS. 9A to 9E are diagrams for explaining a method of acquiring depth information from a background image and calculating a motion vector of a virtual object.

FIGS. 9A and 9B show the same background image as FIG. 4B and FIG. 4C.

FIG. 9C shows a depth image recording the depth of the background image (hand 401) shown in FIG. 9A. FIG. 9D shows a depth image recording the depth of the background image (hand 401) in FIG. 9B. The depth of the background image may be calculated based on the parallax between the two left and right images in the background image, for example. The depth of the background image may be calculated by image processing using machine learning.

FIG. 9E shows a motion vector for moving the user's hand 401 from the state shown in FIG. 9A to the state shown in FIG. 9B. This motion vector may be a motion vector on a two-dimensional image. This motion vector may also be calculated as a three-dimensional motion vector according to the change in the depth of the depth image shown in FIG. 9C and FIG. 9D.

As described above, in image synthesis using the velocity vector and depth information of a virtual object rendered using a past position and orientation, the display position of the virtual object is corrected using the latest position and orientation of the real object. In this way, it is possible to reduce positional misalignment of the virtual object.

In the above embodiment, the mobile terminal worn by the user is an HMD. The mobile terminal used by each user is not limited to an HMD and may be a smartphone or a tablet terminal.

Additionally, in the above, the expression “in a case where A is no less than B, the flow advances to step S1, and in a case where A is smaller than (lower than) B, the flow advances to step S2” may be interpreted as “in a case where A is greater (higher) than B, the flow advances to step S1, and in a case where A is not more than B, the flow advances to step S2.” Conversely, “in a case where A is greater (higher) than B, the flow advances to step S1, and in a case where A is not more than B, the flow advances to step S2” may be interpreted as “in a case where A is no less than B, the flow advances to step S1, and in a case where A is smaller than (lower than) B, the flow advances to step S2.” Accordingly, provided there is no resulting contradiction, the phrase “no less than A” may be substituted with “A or greater (higher, longer, more) than A” and may be interpreted as “greater (higher, longer, more) than A.” Conversely, the phrase “not more than A” may be substituted with “A or smaller (lower, shorter, less) than A” and may be interpreted as “smaller (lower, shorter, less) than A.” Furthermore, “greater (higher, longer, more) than A” may be interpreted as “no less than A,” and “smaller (lower, shorter, less) than A” may be interpreted as “not more than A.”

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

According to the present invention, when an image of a real space and an image of a virtual space are synthesized, a virtual object can be placed at a more appropriate position.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-088840, filed on May 31, 2024, which is hereby incorporated by reference herein in its entirety.

What is claimed is:

1. An information processing device comprising:
one or more processors and/or circuitry configured to:
perform an image acquisition process for acquiring an image of a virtual space;
perform a first detection process for detecting a first position that is a position of a real object in a first captured image of a real space;
perform a second detection process for detecting a second position that is either a position of the real object in a second captured image referred to when generating the image of the virtual space or a position of a virtual object associated with the real object in the image of the virtual space;
perform a determination process for determining a motion vector indicating a direction and an amount of movement of the virtual object in the image of the virtual space based on the first position and the second position; and
perform a correction process for correcting the position of the virtual object in the image of the virtual space based on the motion vector.

2. The information processing device according to claim 1, wherein the second position is a position of the real object in the second captured image.

3. The information processing device according to claim 1, wherein the second position is the position of the virtual object in the image of the virtual space.

4. The information processing device according to claim 1, wherein the one or more processors and/or circuitry further execute a synthesis process for synthesizing the first captured image and the image of the virtual space corrected by the correction process.

5. The information processing device according to claim 1, wherein in the first detection process, the first position is detected based on a difference between the first captured image and an image of a frame immediately preceding the first captured image, an image of the real object, or a value measured by a sensor provided on the real object.

6. The information processing device according to claim 1, wherein the position of the virtual object is detected based on data used to generate the image of the virtual object, or an inter-frame difference in the image of the virtual space.

7. The information processing device according to claim 1, wherein
in the image acquisition process, an image of the virtual space and a depth image showing a depth of the virtual object for each pixel are acquired, and
in the correction process, the position of the virtual object in the image of the virtual space is corrected based on the motion vector and the depth image.

8. The information processing device according to claim 1, wherein
in the image acquisition process, an image of the virtual space and a velocity image showing the velocity of the virtual object for each pixel are acquired, and
in the correction process, the position of the virtual object in the image of the virtual space is corrected based on the motion vector and the velocity image.

9. The information processing device according to claim 1, wherein
in a case where the first position has not changed by more than a threshold,
the motion vector is not determined in the determination process, and
the position of the virtual object is not corrected in the correction process.

10. An information processing method comprising:
acquiring an image of a virtual space;
detecting a first position that is a position of a real object in a first captured image of a real space;
detecting a second position that is either a position of the real object in a second captured image referred to when generating the image of the virtual space or a position of a virtual object associated with the real object in the image of the virtual space;
determining a motion vector indicating a direction and an amount of movement of the virtual object in the image of the virtual space based on the first position and the second position; and
correcting the position of the virtual object in the image of the virtual space based on the motion vector.

11. A non-transitory computer-readable storage medium that stores a program, wherein the program causes a computer to execute an information processing method comprising:
acquiring an image of a virtual space;
detecting a first position that is a position of a real object in a first captured image of a real space;
detecting a second position that is either a position of the real object in a second captured image referred to when generating the image of the virtual space or a position of a virtual object associated with the real object in the image of the virtual space;
determining a motion vector indicating a direction and an amount of movement of the virtual object in the image of the virtual space based on the first position and the second position; and
correcting the position of the virtual object in the image of the virtual space based on the motion vector.
